(19) United States
(12) Patent Application Publication
(10) Pub. No.: US 2006/0258802 A1
(43) Pub. Date: Nov. 16, 2006

(54) Dispersions of rigid-chain conjugated polymers, method for the production and use thereof for producing electronic components

(75) Inventors: Silvia Janietz, Stahnsdorf (DE); Hartmut Kruger, Potsdam (DE); Armin Wedel, Teltow (DE); Dessislava Sainova, Potsdam (DE)

Correspondence Address: EDWARDS & ANGELL, LLP, P.O. BOX 55874, BOSTON, MA, 02205, US

(73) Assignee: Fraunhofer-Gesellschaft zur Forderung derangewand- ten Forschung e.V., Munchen (DE)

(21) Appl. No.: 10/559,437

(22) PCT Filed: May 6, 2004
(86) PCT No.: PCT/EP04/04839

§ 371 Date: Apr. 24, 2006

(30) Foreign Application Priority Data
Jun. 3, 2003 (DE) 103 25 102.2

(51) Int. Cl. C08G 67/02

(52) U.S. Cl. 524/612

(57) ABSTRACT

The invention provides dispersions of rigid-chain conjugated polymers, processes for their manufacture and the use thereof for the manufacture of electronic components. The process according to the invention comprises the steps of a) preparing a solution of the polymer in a strong acid or in a liquid mixture comprising a Lewis acid; and b) introducing the solution prepared in step a) into an aqueous surfactant solution so as to form a dispersion of the polymer. Thus, the invention provides a dispersion of such a polymer in an aqueous or organic or aqueous-organic dispersion medium, wherein the size of the dispersed polymer particles lies in the range of 10 to 800 nm. The dispersions according to the invention may be used for the manufacture of a thin film of the polymer, in particular, for electronic components.

### FIELD OF THE INVENTION

The present invention relates to dispersions of rigid-chain conjugated polymers, a process for their manufacture and their use for the manufacture of electronic components.

In particular, the invention relates to the manufacture of ready-to-use dispersions of such polymers, the particle size of which lies in the nanometer range and which may be used as active materials in electronic components, such as field effect transistors, organic LEDs or in photovoltaic cells.

### BACKGROUND OF THE INVENTION

Rigid-chain conjugated polymers are of interest as active materials for electronic components, in particular, because of their semiconductive properties. They comprise, inter alia, aromatic heterocyclic ladder polymers, such as poly(benzobisimidazobenzo-phenanthroline) (BBL), polyquinolines, polybenzothiazoles, polybenzoimidazoles, polyheterodiazoles.

Such polymers, which ideally have a rod-like shape, are normally entirely insoluble in common organic solvents as well as in water and in aqueous solvents or solvent mixtures. Despite their interesting mechanical and electrical properties, which result from the virtually parallel arrangement of the rod-shaped conjugated molecules in the solid state, such as their high thermal stability, good mechanical strength and their semiconductive character, these polymers are not yet commonly used for technically relevant products. The reason for this may be that they are sufficiently soluble only in concentrated acids, such as sulfuric acid, methane sulfonic acid or by complexation with Lewis acids (nitroalkanes/Lewis acid mixtures; S. A. Jenekhe P. O. Johnson, Macromolecules 1990, 23, 4419-4429) and that the processing of these solutions is not technically feasible.

However, it may be expected that these rigid-chain conjugated polymers exhibit interesting electronic properties due to their rod-shaped arrangement and their semiconductive properties in the solid state.

### STATE OF THE ART

Jenekhe et al. recently published results relating to a thin-layer transistor which contained the ladder polymer poly(benzobisimidazobenzo-phenanthroline) (BBL) as the active layer (A. Babel, S. A. Jenekhe, Adv. Mater. 2002, 14, 371-374). It could be shown that it is possible with this material, for the first time, to prepare a n-semiconductive polymer transistor with electron mobilities of up to 5×10⁻⁴ cm²/Vs. However, this could be achieved only by means of a very complex and technically hardly feasible layer formation process. This involved dissolving the rigid-chain BBL in methane sulfonic acid in order to prepare thin layers thereof by spin coating. The active layer thus obtained can be used only after complicated washing steps (treatment with 10% triethylamine solution in ethanol, washing with water and drying in vacuum at 60° C.). While this process may be practicable on a laboratory scale, it is not feasible as an industrial process.

The solubility of the rigid-chain conjugated polymers described above in common organic solvents such as chloroform, toluene, xylene etc. may possibly be achieved by lateral substitution with, for example, alkyl, alkoxy or dialkylamino groups. However, in the majority of polymer syntheses this requires a markedly increased synthetic effort. Moreover, in many cases such substitution is subject to certain limitations (for example, in the case of BBL). Furthermore, lateral substituents may adversely affect the electronic properties. Therefore, the solubilization of a rigid-chain conjugated polymer by introduction of lateral substituents into the polymer structure does not normally constitute a practicable or advantageous possibility for the preparation of ready-to-use solutions or dispersions of these materials.

### SUMMARY OF THE INVENTION

Thus, it is an object of the invention to provide a process by which rigid-chain conjugated polymers, which are insoluble in organic solvents, may be converted to a form in which they may be conveniently processed and which is suitable, in particular, for the manufacture of thin films of these polymers.

This object is achieved according to the present invention by a process for the manufacture of a dispersion of a rigid-chain conjugated polymer, which is insoluble in organic solvents, in an aqueous or organic or aqueous-organic dispersion medium, comprising the steps: a) preparing a solution of the polymer in a strong acid or in a liquid mixture comprising a Lewis acid; and b) introducing the solution prepared in step a) into an aqueous surfactant solution so as to form a dispersion of the polymer.

According to the invention, there is thus provided a dispersion of a rigid-chain conjugated polymer, which is insoluble in organic solvents, in an aqueous or organic or aqueous-organic dispersion medium, wherein the size of the dispersed polymer particles lies in the range of 10 to 800 nm.

Furthermore, the invention comprises the use of such a dispersion for the manufacture of a thin film of a rigid-chain conjugated polymer and for the manufacture of an electronic element.

### BRIEF DESCRIPTION OF THE DRAWINGS

FIG. 1 shows an scanning electron microscopic image of a thin film of BBL particles on Al (BBL particles in 0.1% surfactant/water solution, solids content 1%).

FIG. 2 shows an scanning electron microscopic image of a thin film of BBL particles on Al (BBL particles in 1% surfactant/water solution, solids content 1%).

FIG. 3 shows an scanning electron microscopic image of a thin film of BBL particles on Al (BBL particles in 0.1% surfactant/THF solution, solids content 1%).

FIG. 4 shows an image of the film shown in FIG. 3 at a larger scale.

FIG. 5 shows the characteristics of an organic field effect transistor (OFET) which has been prepared by using a dispersion of poly(benzobisimidazobenzo-phenanthroline) (BBL) particles according to the present invention.

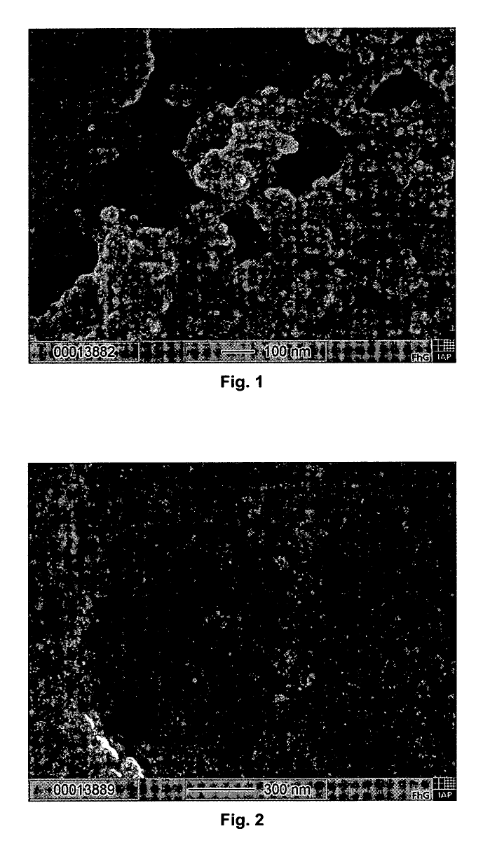

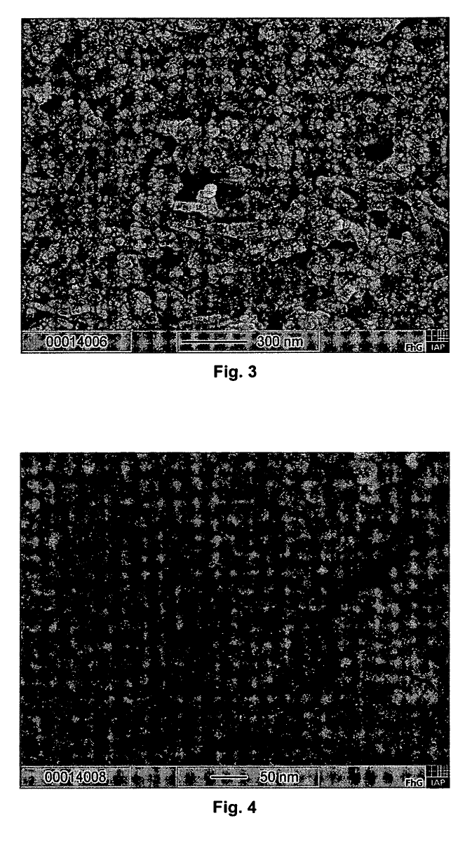

### DESCRIPTION OF PREFERRED EMBODIMENTS OF THE INVENTION

The polymers employed in the process according to the invention are rigid-chain conjugated polymers which are insoluble in organic solvents, in particular, in common organic solvents such as chloroform, toluene and xylene.

The rigid-chain conjugated polymers, which may be used in the process of the present invention, comprise, in particular, aromatic heterocyclic ladder polymers, polyquinolines, polybenzothiazoles, polybenzoimidazoles, polyheterodiazoles and mixtures thereof.

The structural formulae of typical polyheterodiazoles (Formula (I)), polyquinolines (Formula (II)) and polybenzothiazoles or polybenzoimidazoles (Formula (III)) are shown below:

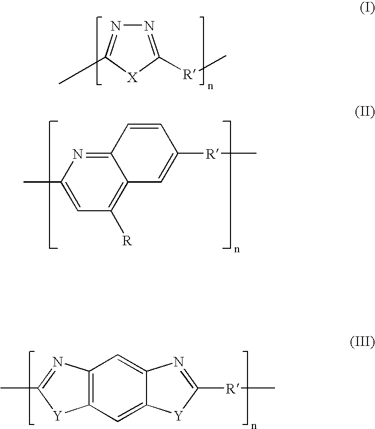

In these formulae, each R′ represents a divalent aromatic or heteroaromatic residue; R represents an aryl or aralkyl group; X represents N-alkyl, N-aryl, O, S or SO₂; and Y, independently, represents N—H; N-alkyl, N-aryl, O or S.

The process according to the present invention is suitable, in particular, for the preparation of dispersions of poly(benzobisimidazobenzo-phenanthroline) (BBL), the structure of which is shown in Formula (IV).

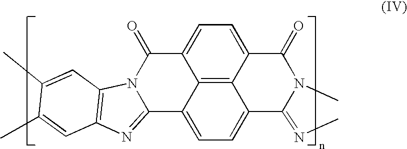

The polymers employed in the process according to the present invention typically have intrinsic viscosities in methane sulfonic acid at room temperature of 1.3 to 6 dl/g, preferably 1.5 to 3 dl/g.

The dispersion medium of the dispersions prepared according to the process of the present invention is an aqueous or organic or aqueous-organic dispersion medium. Thus, the dispersion medium consists essentially of water, or an organic solvent, such as chloroform, toluene, xylene, tetrahydrofuran (THF) or cyclohexanol. The dispersion medium may also consist of a mixture of water and an organic solvent which is miscible with water. In particular, the dispersion medium is substantially free of substances which substantially hamper the processing of the dispersion, especially at an industrial scale. Such substances comprise, in particular, strong acids, strongly corrosive substances or strongly toxic substances. Therefore, the dispersions prepared according to the process of the present invention may be used, in particular, in conventional processes for the preparation of thin polymer films.

In the first step of the process according to the present invention, the polymer is dissolved in a strong acid or in a liquid mixture containing a Lewis acid. The strong acid is preferably methane sulfonic acid or concentrated sulfuric acid or a mixture thereof. The mixture containing a Lewis acid is preferably a mixture of a Lewis acid with a nitroalkane or a nitroaromatic compound, such as nitromethane or nitrobenzene. The Lewis acid is preferably GaCl₃, AlCl₃, FeCl₃, or SbCl₃. The content of the Lewis acid in the mixture is preferably 30 to 90 wt-%.

The concentration of the polymer in the solution prepared in the first step of the process according to the present invention is typically 0.1 to 5 wt-%, preferably 0.5 to 2 wt-%.

In the second step of the process according to the present invention, the solution prepared in the first step is introduced into an aqueous surfactant solution. This is done so that the polymer forms a dispersion. In order to form a stable dispersion, the introduction of the solution of the polymer into the aqueous surfactant solution is preferably conducted under the influence of ultrasound. Commercially available ultrasonic homogenizers are particularly useful for this purpose.

Useful surfactants are ethoxylates and polyethylene glycols and, in particular, fatty amine ethoxylates. These are generally of a basic nature.

The dispersion of the rigid-chain conjugated polymer obtained in the second step of the process according to the present invention contains the solvent used in the first step (the strong acid or liquid mixture containing a Lewis acid) only in a highly diluted form. Nevertheless, it is generally preferable to subsequently, carry out the following steps: separating the dispersed polymer from the liquid phase of the dispersion obtained in the second step; washing the separated polymer and re-dispersing the washed polymer in an aqueous or organic surfactant solution.

The separation of the dispersed polymer can be carried out, in particular, by centrifuging and decanting of the supernatant solution. The separated polymer (centrifugate) may then be taken up again in water in order to wash it. This procedure (centrifuging and taking up in water) is preferably repeated until the pH of the supernatant solution is neutral.

After the washing, the dispersed polymer is re-dispersed in an aqueous or organic surfactant solution. This redispersing, too, is preferably carried out under the influence of ultrasound. Suitable dispersion media comprise, in particular, a solution of one of the aforementioned surfactants in water or in an organic solvent such as chloroform, toluene, tetrahydrofuran or cyclohexanone, or in a mixture of water and an organic solvent which is soluble in water, such as tetrahydrofuran. The concentration of the surfactant solution used in the process according to the present invention is preferably 0.01 to 5 wt-%, more preferably 0.05 to 2 wt%.

The process according to the present invention provides a dispersion of a rigid-chain conjugated polymer, which is insoluble in organic solvents, in an aqueous or organic or aqueous-organic dispersion medium, wherein the size of the dispersed polymer particles lies in the range of 10 to 800 nm, preferably 10 to 100 nm. Apart from the surfactants contained therein, the dispersion medium consists essentially of water or an organic solvent, such as chloroform, toluene, tetrahydrofuran or cyclohexanone, or of a mixture of water and an organic solvent which is miscible with water, such as tetrahydrofuran. In particular, the dispersion medium of the dispersion according to the present invention is free of substances which substantially hamper the industrial processing of the dispersion for the manufacture of thin films of rigid-chain conjugated polymers, such as strong acids.

Accordingly, the stable dispersions according to the present invention are suitable, in particular, for the manufacture of thin layers by drop casting or spin coating processes. Such thin layers may be used, in particular, as active charge carrier layers in electronic components, such as field effect transistors, organic LEDs or photovoltaic cells.

### EXAMPLES

The invention will hereinafter be illustrated by preparation and application examples. The ladder polymer poly(benzobisimidazobenzo-phenanthroline) (BBL) used therein was synthesized with endcapping as described by Arnold et al. (F. E. Arnold, R. L. van Deusen, Macromolecules 1969, 2, 497-502). All percentages are by weight, unless stated otherwise.

Preparation of Stable Aqueous and Organic Dispersions.

A 1% (by weight) BBL solution in methane sulfonic acid was prepared first. For this purpose, 100 mg of BBL were dissolved in 10 g of methane sulfonic acid. Furthermore, a 1% aqueous surfactant solution was prepared from T150. T150 is a surface active Genamin (Hoechst) of the series of tallow fatty amine ethoxylates with 15 molecules of ethylene oxide per molecule of tallow fatty amine. Into 100 ml of this surfactant solution, the BBL-methane sulfonic acid solution was introduced slowly over a period of 4 minutes with a pipette under sonication with the ultrasonic homogenizer HD 2200 (HF power 200 W; HF frequency 20 kHz) at maximum output. The solution was then sonicated for another 4 minutes. The dispersion thus obtained was centrifuged (45 min, 4500 rpm). The centrifugate was decanted from the supernatant solution and repeatedly taken up in water and centrifuged again. This procedure was repeated until the pH of the washing solution was neutral (about 4 to 6 times). The centrifugate was then re-dispersed in a water/surfactant solution (10 ml of a 1% or 0.1% solution of T150 in water) under ultrasonication at maximum power (4 minutes of ultrasound). This results in stable dispersions with particle sizes in the range of 15 to 100 nm.

Re-Dispersion in Tetrahydrofuran

In this case, the centrifugate washed to neutrality was re-dispersed in a tetrahydrofuran/surfactant solution (10 ml of a 0.1% solution of T150 in tetrahydrofuran) under ultrasonication (4 minutes of ultrasound, at maximum power). This also resulted in stable organic dispersions with particle sizes in the range of <100 nm.

Characterization of the Particles

The average particle size was determined by ultracentrifuge and confirmed by scanning electron microscopy. Scanning electron microscopy was carried out with a JSM6330F microscope manufactured by Joel. The sample preparation was carried out as follows: The object slide was drop-coated with the sample and a 4 nm thick layer of platinum was subsequently sputtered onto the sample. The sample thus prepared was evaluated at an acceleration voltage of 5 kV.

The results for dispersions according to the present invention in various dispersion media are summarized in Table 1.

TABLE 1
Average particles sizes for samples of dispersions according
to the present invention of
poly(benzobisimidazolbenzo-phenanthroline) (BBL) in various
dispersion media (solids content 1%)

| Sample | | average particle | see |
|---|---|---|---|
| No. | Dispersion medium | size | FIG. (s) |
| 1 | 0.1% surfactant/water solution | 25-50 nm | 1 |
| 2 | 1% surfactant/water solution | 15-30 nm | 2 |
| 3 | 0.1% surfactant/THF solution | 25-50 nm | 3, 4 |

Construction of an Organic Field Effect Transistor (n-Type)

Active charge carrier layers in electronic components with layer thicknesses of 800 to 15 nm (limited by the particle size), such as in an organic field effect transistor (OFET), were prepared by dropping or spin-coating of the stable aqueous dispersions with solids contents of 10 to 0.5% and surfactant contents of 10 to 0.05% and subsequent drying of the layer.

Field effect transistors with bottom gate structure were constructed. The OFET structures used were characterized as follows: source drain (aluminium) spacing: 20 μm, W/L ratio: 360, gate layer thickness (SiO₂): 500 nm.

The aqueous 1% surfactant-containing dispersion with a solids content of 1% of poly(benzobisimidazobenzo-phenanthroline) (BBL) particles (Table 1, Sample No. 2) was dropped onto a transistor structure in a glove box and subsequently heated for 2 hours at 110° C. in order to remove the water.

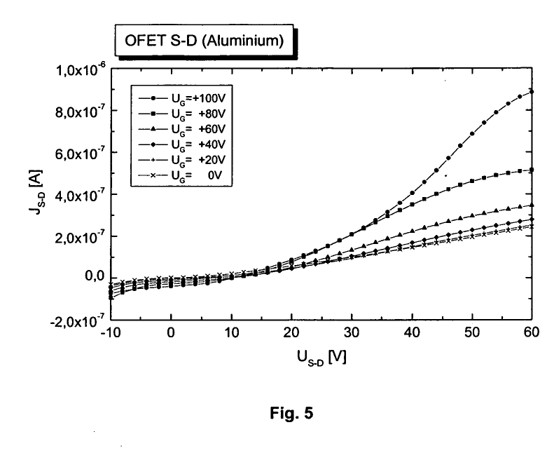

The characteristics of an OFET structure with poly(benzobisimidazobenzo-phenanthroline) (BBL) particles thus obtained are shown in FIG. 5. These show a marked field effect (FIG. 5) and a saturation behavior from which the charge carrier mobilities may be determined.

The characteristic field of the OFETs with poly(benzobisimidazobenzo-phenanthroline) (BBL) particles gave a charge carrier mobility of, at most, 1.2×10⁻⁵cm²/VS.

1-16. (canceled)

17. A process for the preparation of a dispersion of a rigid-chain conjugated polymer, which is insoluble in organic solvents, in an aqueous or organic or aqueous-organic dispersion medium, comprising steps of:
a) preparing a solution of the polymer in a strong acid or in a liquid mixture comprising a Lewis acid; and
b) introducing the solution prepared in step a) into an aqueous surfactant solution so as to form a dispersion of the polymer.

18. The process according to claim 17, wherein, after step b), the following further steps are carried out:
c) separating the dispersed polymer from the aqueous phase of the dispersion obtained in step b);
d) washing the separated polymer;
e) re-dispersing the washed polymer in an aqueous or organic surfactant solution.

19. The process according to claim 17, wherein step b) and, optionally, step e) are carried out under the influence of ultrasound.

20. The process according to claim 17, wherein the rigid-chain conjugated polymer is selected from the group consisting of aromatic, heterocyclic ladder polymers, polyquinolines, polybenzothiazoles, polybenzoimidazoles, polyheterodiazoles and mixtures thereof.

21. The process according to claim 17, wherein the rigid-chain conjugated polymer is poly(benzobisimidazobenzo-phenanthroline) (BBL).

22. The process according to claim 17, wherein the strong acid employed in step a) is methane sulfonic acid or concentrated sulfuric acid.

23. The process according to claim 17, wherein a solution of the polymer in a nitroalkane/Lewis acid mixture is prepared in step a).

24. The process according to claim 17, wherein the surfactant employed in step b) or in step e) is selected from the group consisting of ethoxylates, polyethylene glycols and fatty amine ethoxylates.

25. The process according to claim 17, wherein the content of the polymer in the solution prepared in step a) is 0.1 to 5 wt-%.

26. The process according to claim 17, wherein the content of the surfactant in the surfactant solution employed in steps b) or e) is 0.01 to 5 wt-%.

27. The process according to claim 17, wherein the size of the dispersed polymer particles in the dispersion produced lies in the range of 10 to 800 nm.

28. A dispersion of a rigid-chain conjugated polymer, which is insoluble in organic solvents, in an aqueous or organic or aqueous-organic dispersion medium, wherein the size of the dispersed polymer particles lies in the range of 10 to 800 nm.

29. The dispersion according to claim 28, wherein the dispersion medium consists essentially of water or a mixture of water and an organic solvent which is miscible with water.

30. A method for preparing a thin film of a rigid-chain conjugated polymer, comprising using a dispersion according to claim 28.

31. A method for preparing an electronic element comprising using a dispersion of claim 28.1

32. The method of claim 31 wherein the electronic element is a field effect transistor, an organic LED or a photovoltaic cell.
